(19) United States
(12) Patent Application Publication
(10) Pub. No.: US 2005/0072507 A1
(43) Pub. Date: Apr. 7, 2005

(54) Anisotropic homogeneous elastomeric closed torus tire design & method of manufacture

(76) Inventors: Dennis S. Chrobak, Silver Lake, OH (US); James A. Chrobak, Akron, OH (US)

Correspondence Address: Hahn Loeser + Parks;Twin Oaks Estate, 1225 W. Market Street, Akron, OH, 44313, US

(21) Appl. No.: 10/910,778

(22) Filed: Aug. 3, 2004

Related U.S. Application Data
(63) Continuation of application No. 09/849,854, filed on May 4, 2001, now abandoned.

(51) Int. Cl. B60C 5/01; B60C 3/00; B60C 7/00; B60C 19/04; B60C 13/00; B60C 15/024

(52) U.S. Cl. 152/452; 152/515; 152/523; 152/454; 152/455; 152/327; 152/544; 29/894.31

(57) ABSTRACT

The present invention is directed at a tire design, which allows for proper operational characteristics in all operating conditions, and is not dependent on pneumatic pressurization. The tire is mounted in a wheel rim, and comprises an integral homogeneous toroidal body having a pair of spaced-apart radially extending sidewalls and a cross member. Each sidewall has a first and a second end and an internal face and an external face, with the second end of each of the sidewalls integrally merging into the cross member. A set of rim-engaging surfaces at the first end of each of the sidewalls allows effective mounting to conventional tire rims. An annular chamber is defined by the internal faces of the sidewalls and an internal top wall on the cross member opposite the at least one road engaging surface. The set of rim-engaging surfaces includes a lobe-like portion at the first end of each of the sidewalls, the respective lobe-like projections may be separable when the tire is not mounted on the rim, but being compressed into engagement when the tire is mounted in the rim, thereby closing the annular chamber, or integral with one another to form the enclosed chamber.

### RELATE BACK

“This application is a continuation of copending application application Ser. No. 09/849,854 filed on May 4, 2001.”

The present invention relates to a tire construction, which utilizes characteristics of the elastomeric tire shell construction without requiring internal pneumatic pressure as the primary performance determinant, the shell having an effectively homogeneous composition and providing a closed toroidal structure. The shell provides an anisotropic or isotropic assembly when mounted in a wheel rim.

### BACKGROUND OF THE INVENTION

Vehicle tires, especially those for automobiles, motorcycles, bicycles and other vehicles, generally comprise a pressure-containing shell. The shell is seated in a sealing manner onto a wheel rim in order to convert an open chamber in the tire interior into a pressure-retaining closed chamber. The tire supports the load by inflation pressure placing the unloaded shell portion into tension. To provide the pressure-retaining characteristics but to minimize weight, the tire sidewalls tend to be thinner than the radially outward road or other surface engaging tread portion. The road engaging surface is provided with tread features designed to allow good control under various road conditions or for a particular environment, while attempting to provide reduced road noise, or other characteristics.

Traditionally, pneumatic tires of the prior art are built up in layers of rubber compounds and incorporate polymeric or metallic fiber materials to provide strength. A metallic bead element is built up in the tire in the rim seat region in a manner to establish and maintain the pneumatic-pressure retaining seal upon which operation depends. These tires are formed from materials in the solid state that remain in the solid state throughout the fabrication process. This general tire construction is complex to manufacture, and the characteristics of the rubber compounds and ultimate solid state layers are difficult to control. Problems in the manufacturing process or design of the tire to perform a given duty cycle can lead to tire failure. Due to the reliance upon inflation pressure, any failure can in turn result in significant problems in handling of the vehicle and dangerous operating conditions, let alone rendering the tire inoperative.

Problems also exist with respect to the high deflection of the tire tread, increasing the rolling resistance and reducing the performance characteristics with respect to mileage or wear of this type of tire design. Further, with the inflation pressure impacting upon deflection and rolling resistance, the tire design can't be optimized. Attempts have been made to provide highly fuel efficient tires for use with vehicles having engines, such as in European Patent No. 0 119 152, wherein specific dimensional and physical characteristics provide decreased rolling resistance, but the pneumatic tire is still reliant upon inflation pressure for operation.

In the alternative, some tires known early in the automotive industry were formed as solid hard rubber designs. These tires exhibited virtually no resilience, and were useful only on large diameter, narrow width rims, similar to buggy wheels. Such tires and rims are entirely impractical on modern vehicles. But there have been attempts to get around the problems associated with pneumatic tires, and based upon compression loading for support and not inflation pressure.

In fact, it may be noted that tire technologies may be generally classified on a pair of spectra. One of the spectra represents the type of engineered structure, and runs from pneumatic or tensional systems in which the tires operate under high inflation pressures (up to 10 atmospheres or so), through hybrid tension/compression systems to pure compressional systems in which there is no inflation pressure in the tire. Examples of hybrid tension/compression systems include “run flat” tire technologies. These tires are able to run after inflation pressure is lost. In general, such attempts have utilized a mass of rubber provided along the inside of the sidewall portions to support tire loads during running under flat conditions, which are commonly limited to about 200 miles at speeds not to exceed about 50 mph. This results in an increase in tire weight, and creates additional heat, running under flat conditions as well as normal conditions. This in turn can result in degradation of the tire and failure. Other approaches have attempted to use high rigidity materials to provide structural integrity after loss of pneumatic pressure, or filling the tire with an elastic material having some degree of rigidity to support the tire load when the tire air pressure is lost. Such attempts have not provided a satisfactory solution to the problem of losing inflation pressure in pneumatically pressurized tire constructions. Other systems, such as shown in U.S. Pat. No. 5,027,876 or U.S. Pat. No. 3,961,657 have been proposed as alternatives. An example of a compression based tire technology is shown in U.S. Pat. No. 5,743,316.

The other spectrum represents the type of materials used in the fabrication. At one extreme, the materials used to construct the tire are solid and remain in the solid state throughout the fabrication, such as in typical pneumatic tires. Alternatively, the tire is formed from solid and liquid materials or purely from liquid materials, which are solidified during processing. Examples of solid and liquid phase processing are shown in of U.S. Pat. No. 5,254,405 and European Patent No. 0 374 081 A2. Although various alternative strategies have been attempted to provide desired tire characteristics, no tire design heretofore has provided the desired characteristics in a simple and cost-effective configuration.

It is, therefore, an unmet need of the prior art to provide a tire construction having a design which does not rely only upon internal pneumatic pressurization for proper operation. There is also a need to provide a tire design which has very low rolling resistance and yet performs in a manner similar to typical pneumatic tires. A further need is found in providing a tire design which allows for a simplified and repeatable manufacturing process to provide proper operational characteristics in all operating conditions and applications.

### SUMMARY OF THE INVENTION

The present invention is therefore directed at a tire design and method of manufacturing which avoids the problems associated with prior tire designs, and allows for proper operational characteristics in all operating conditions. The invention is further directed at providing a compression tire construction which is engineered such that the normal rolling resistance of the tire is reduced significantly relative to a tension tire, even if the tension tire were inflated to a very high inflation pressure. These advantages, and others, are provided by a tire for mounting on a wheel rim, which comprises a homogeneous toroidal body having a pair of spaced-apart radially extending sidewalls and a cross member. Each sidewall has a first and a second end and an internal face and an external face, with the second end of each of the sidewalls integrally merging into the cross member. A set of rim-engaging surfaces at the first end of each of the sidewalls allows effective mounting to conventional tire rims. At least one road-engaging surface on an external surface of the cross member may be provided with appropriate tread characteristics to facilitate proper performance of the tire. In an embodiment, an annular chamber is defined by the internal faces of the sidewalls and an internal top wall on the cross member opposite the at least one road-engaging surface. The chamber may be formed by forming the tire into a closed torus shape, or providing the rim-engaging surfaces as independent lobe-like portions being separable when the tire is not mounted on the rim, but being compressed into engagement when the tire is mounted in the rim, thereby closing the annular chamber. The rim may also be used to close the chamber to form a closed toroid, which is placed into compression under load.

In another embodiment, a homogenous body is formed as a generally flat member who is folded or shaped into a form for engagement with the tire rim. Circumferential and/or radial anisotropy is built into the structure for distribution of loading stresses upon mounting on the rim. The compression tire of the invention is designed such that it can be engineered for a particular application in a manner such that its normal rolling resistance is reduced significantly, such as compared to a typical pressurized tire construction. The design can be optimized for a particular application, to reduce rolling resistance while maintaining other desired attributes in operational characteristics. Methods of manufacturing are also set forth according to the invention.

### BRIEF DESCRIPTION OF THE DRAWINGS

The present invention will be best understood when reference is made to the detailed description of the invention and the accompanying drawings, wherein identical parts are identified by identical reference numbers and wherein:

FIG. 1 is a section of an embodiment tire of the present invention;

FIG. 1A is a cross-sectional view of an alternate embodiment of the present invention;

FIG. 2 is a section of another embodiment tire of the present invention;

FIGS. 3 through 8 are cross-section views of the tire of the present invention from a finite element analysis computer simulation to show the dynamic stress reaction of the tire to load;

FIG. 9 is a section of a body for forming an embodiment of a tire showing how it may be manufactured; and

FIGS. 10A and 10B are sectional views of a further embodiment of the invention.

### DETAILED DESCRIPTION OF THE PREFERRED EMBODIMENT

A first embodiment tire 10 of the present invention is shown with a section thereof in perspective view in FIG. 1. As will be readily understood, the tire 10 is an integral toroidal body with significant symmetries, so there is no need to illustrate the remainder of the tire when shown in diametrical section. The tire 10 has several characteristic features which are readily observed in FIG. 1. Particularly, the tire 10 is formed as a wedge-shaped body in cross-section, with a width that increases as the radial distance from the center of the torus increases. This means that a set of rim-engaging surfaces 12 are narrower in width than the width of a cross or tread member 13 on which is one or more road engaging surfaces 14. It should be understood that reference to a road engaging surface 14 may also relate to engaging surfaces other than roads, for vehicles which are not used on road surfaces. Between the rim-engaging surfaces 12 and the road-engaging surfaces 14 are a pair of spaced-apart sidewalls 16, a radially outward end of each sidewall integrally merged into the cross member 13. The tire 10 has an internal annular chamber 18 with a pair of internal sidewall faces 20 and an internal top wall face 22 which is a part of the cross member 13.

The sidewalls 16 are notably distinct from known tire sidewalls because the external face 24 has a concave sculpted curvature and the internal sidewall face 20 is provided with a sculpted concave curvature when viewed from within the annular chamber 18. These opposing curvatures result in the sidewalls 16 having a thickness which varies radially inwardly or outwardly. Conventional tires typically have convex external sidewall surfaces and concave internal sidewall surfaces with a generally constant wall thickness, and are inflated to support the vehicle with internal pressure.

As will be described with reference to further embodiments of the invention, the tire may include anisotropic features both radially and circumferentially to facilitate distribution of stress and accommodating a given duty cycle as required. Anisotropic refers to providing properties in portions of the tire having different values when measured along different directions within the tire. As seen in FIG. 1A, circumferential anisotropic features 40 may be formed on the internal sidewall faces 20 and/or the internal top wall face 22. The anisotropic features 40, in accordance with one aspect of the invention, may comprise a series of alternating ridges 42 and grooves 44 which extend circumferentially along one or more portions of the internal annular chamber 18. The series of ridges 42 and grooves 44 may be molded to the inside surface of the annular chamber 18, and may be configured as shown in FIG. 1A, are substantially sinusoidal and cross-sectional configuration, or alternatively may be otherwise configured to have rounded ridges with flat grooves, triangular cross-sectional ridges and grooves, rectangular sectional ridges and grooves or other suitable shapes to provide desired anisotropy in the given tire design. Additionally, if desired for a particular application radial anisotropic features may be provided in conjunction with sidewall faces 20. The provision of anisotropic features within the tire design allows the carrying and distribution of load on the tire in an effective manner to optimize performance and life cycle characteristics for a given duty cycle.

As will be hereinafter described, the tires according to the invention may be manufactured using liquid phase processing techniques, producing a homogenous tire body. Anisotropy may be provided in the tire design by formation of reinforcing structures circumferentially and/or radially within the inside surface of the toroidal structure. Such reinforcing structures may be formed integrally with the tire during molding, casting, etc., or the reinforcing structures may be formed and adhered to the inside surfaces if desired. The reinforcing structures may also be provided on other embodiments of the invention, and again may be a series of alternating ridges and grooves which extend circumferentially and/or radially within the closed toroidal structure of the tire. The shapes of the alternating ridge and groove structures may be of any desired configuration.

At the radially outward end of the tire 10, the cross member 13 and its external road-engaging surface 14 has a convex curvature across the width, effectively forming a crown which may be depressed against the road surface upon loading. Inside the annular chamber 18, the internal top wall face 20 of the cross member is concavely curved when viewed from the annular chamber, so that this portion of the tire has a generally constant thickness. Of course, it will be well known to put road-engaging tread features 26, such as dimples, holes, grooves and the like onto the external road-engaging surface 14 to edges thereof, but it is the general thickness of the cross member 13 and not the localized thickness thereof which is generally constant.

At the radially inwardly end of each sidewall 16, a number of rim-engaging surfaces 12 are provided. First, a concave groove 28 is sized and positioned around the circumference to allow the tire 10 to be seated in a rim with an inwardly-projecting seating surface. Second, a lobe-like thickened portion 30 is situated on each sidewall 16, with each of the portions 30 having a convexly curved outer surface 32. While a slight separation 34 is shown between the sidewalls 16 in FIG. 1, it will be recognized that upon compressively fitting the tire 10 into a rim, the lobe-like portions 30 will be compressed against each other, and the convexly curved outer surfaces will conform compressively into engagement with the internal surfaces of the rim. This means that the tire 10, while not a closed torus when dismounted from a proper rim due to separation 34, becomes an effectively closed torus upon mounting. Any air captured in the annular chamber 18 upon the mounting of the tire becomes entrapped and is able to provide a compressible resilient member having a different spring rate than the solid portions of the tire. Alternatively, the tire 10 may be provided with a valve 19 extending to the annular chamber 18 to allow the introduction of pressurized air into this region. In this manner, the tire 10 may be operated as a hybrid compression/tension tire, with the ability to add pressurized air to region 18 possibly providing desirable performance characteristics for various applications. As an example, in a passenger tire, the tire 10 without the introduction of pressurized air to chamber 18, provides improved performance characteristics, which as hereafter described in more detail, may include decreased rolling resistance, resulting in increased mileage and other attributes associated with the vehicle, which can further be enhanced by the introduction of pressurized air into chamber 18. It should be recognized for example, that the introduction of pressurized air to chamber 18 will further decrease the rolling resistance of the tire 10, which for various applications may be desirable. At the same time, the introduction of pressurized air to chamber 18 is not necessary to support the loads for a given duty cycle, and therefore if pressurization is lost from chamber 18, the tire 10 will still perform, providing extended mobility to the vehicle on which it is used. Further, the construction of tire 10 according to this embodiment is distinct from a conventional tire, where virtually all contact between the rim and the tire is borne on radially extending sides of the rim and little or none of the contact is made with the radially facing surfaces of the rim. The tire 10 provides support by means of the sidewall 16 in conjunction with the cross member 13, wherein when mounted to a vehicle, the structure of tire 10 will be loaded under compression to support the vehicle in conjunction with the rim thereof. The design of the tire 10 provides an anisotropic assembly with structurally stable sidewalls 16 even in the absence of any positive pressurization beyond ambient in the annular chamber 18.

It will also be recognized that this possible hybrid tensional-compressional system may be manufactured using a purely liquid phase manufacturing scheme. The tire 10 according to the invention may be manufactured by any suitable manufacturing method, but contemplates a purely liquid phase spin casting manufacturing process to provide significant cost advantages as well as manufacturing control. The invention also contemplates the use of homogenous elastomeric materials, such as urethanes, polyurethanes, composites of polyethylurethane elastomeric particles, rubber compounds, thermoplastic elastomers or combinations thereof, either in mixture or in a laminated construction. The ability to spin cast tires 10 using a homogenous material such as polyurethane, may provide the ability to form a non-porous outer tread or skin with the material becoming increasingly porous downwardly from the tread to the inner surface. The tire 10 then functions as anisotropic assembly, which is capable of carrying the load in compression. The ability to cast tire 10 and form tire 10 in a liquid phase manufacturing process insures consistency in the manufacturing process and materials used to form tire 10. This type of manufacturing process provides a high degree of control over the characteristics of the material produced by the manufacturing process, while drastically reducing the cost of investment in the manufacturing process. The control over the material properties as well as shape and design of the tire 10 therefore allow a great amount of flexibility to the designer for implementing tires 10 according to the invention for a variety of different and varying applications. Thus, the design of tire 10 as shown in this embodiment is only representative of the types of designs possible in accordance with the invention. Depending upon the duty cycle for which the tire 10 is designed, the characteristics of the sidewalls 16 may be modified to support the vehicle load under compression. In all designs, the tire 10 may be configured to fit in association with a standard vehicle rim, whether associated with a bicycle, passenger vehicle, heavy vehicle or the like. In the embodiment shown in FIG. 1, the tire 10 is designed for a power bike type of vehicle intended for road use.

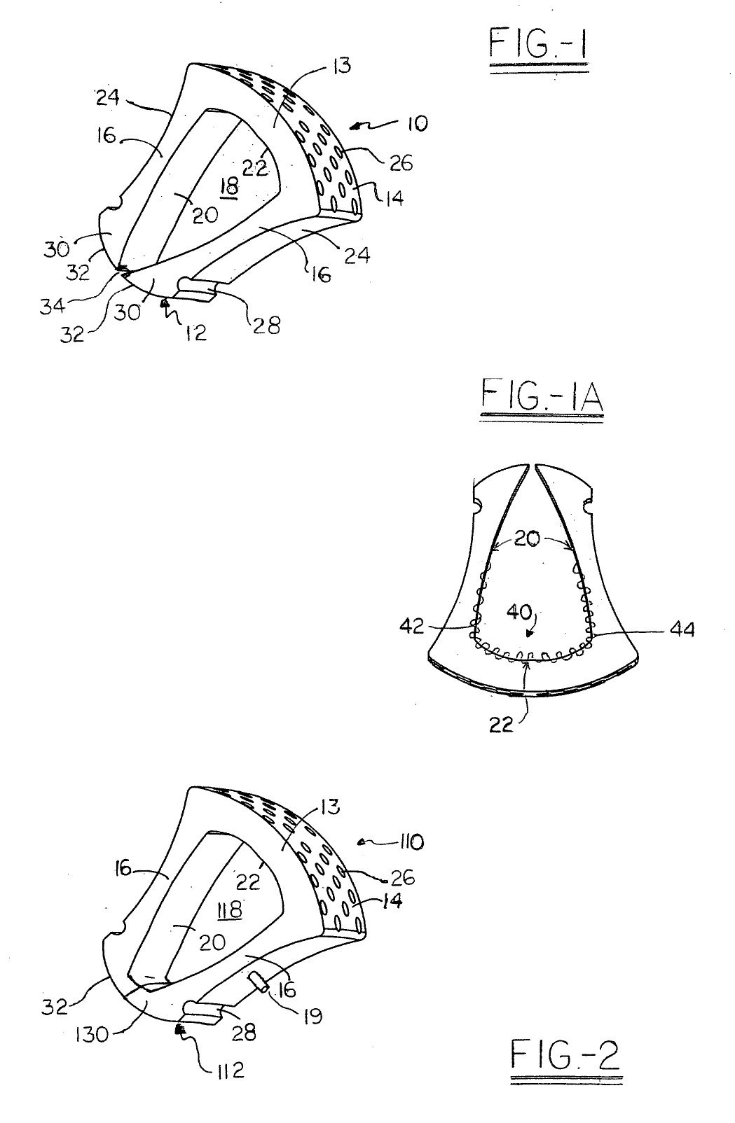

In a second embodiment, a tire 110 is similar to the first embodiment. A section of the second embodiment tire 110 is shown in FIG. 2 in a perspective view. As the tire 110 is toroidal, there is no need to illustrate the other half of the tire when shown in diametrical section, since the other half will be a mirror image of the half-illustrated. The tire 110 has several characteristic features. The tire 110 is somewhat wedge-shaped in cross-section, with a width that increases as the radial distance from the center of the torus increases. This means that a set of rim-engaging surfaces 112 are narrower in width than the width of a cross member 13 having one or more road engaging surfaces 14. Between the rim-engaging surfaces 112 and the cross member 13 are a pair of spaced-apart sidewalls 16, a radially outward end of each of the sidewalls being integrally merged into cross member 13. The tire 110 has an internal annular chamber 118 with a pair of internal sidewall faces 20 and an internal top wall face 22, which is a part of the cross member 13.

The sidewalls 16 are notably distinct from known tire sidewalls because the external face 24 has a concave curvature and the internal sidewall face 20 is concave when viewed from within the annular chamber 118. These opposing curvatures result in the sidewalls 16 having a thickness which varies as one moves radially inwardly or outwardly. Conventional tires typically have convex external sidewall surfaces and concave internal sidewall surfaces with a generally constant wall thickness.

At the radially outward end of the tire 110, the external road-engaging surface 14 has a convex curvature across the width, effectively forming a crown, which may be depressed upon loading. Inside the annular chamber 118, the internal top wall face 20 is concavely curved when viewed from the annular chamber, so that this portion of the tire has a generally constant thickness. Of course, it will be well known to put road-engaging features 26, such as dimples, cylindrical holes, grooves and the like onto the external road-engaging surface 14, but it is the general thickness of the tire and not the localized thickness which is generally constant.

At the radially inwardly end of each sidewall 16, a number of rim-engaging surfaces 112 are provided. First, a concave groove 28 is sized and positioned around the circumference to allow the tire 110 to be seated in a rim with an inwardly-projecting seating surface. Second, the sidewalls 16 are conjoined by a lobe-like thickened portion 130 formed at the base of each sidewall 16, with the portion 130 having a convexly curved outer surface 32. As the tire 110 is mounted in a rim, the act of compressively fitting the tire into the rim will accomplish two goals: the lobe-like portion 130 will be compressed between radially-extending sides of the rim, and the convexly curved outer surface 32 will conform compressively into engagement with the internal surfaces of the rim. Annular chamber 118 is a closed air-retaining chamber whether the tire 110 is mounted or not. The design of the tire 110 provides an anisotropic assembly with structurally stable sidewalls 16 even in the absence of any positive pressurization beyond ambient in the annular chamber 118. Also similar to the previous embodiment, the annular chamber 118 may be pressurized with air if desired, to modify the load bearing or handling characteristics of the tire if desired.

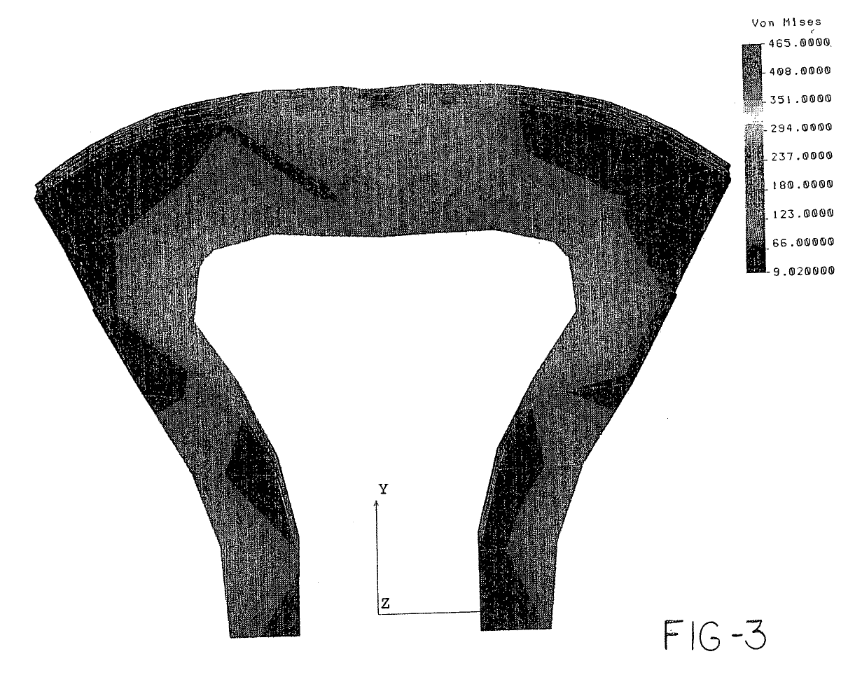

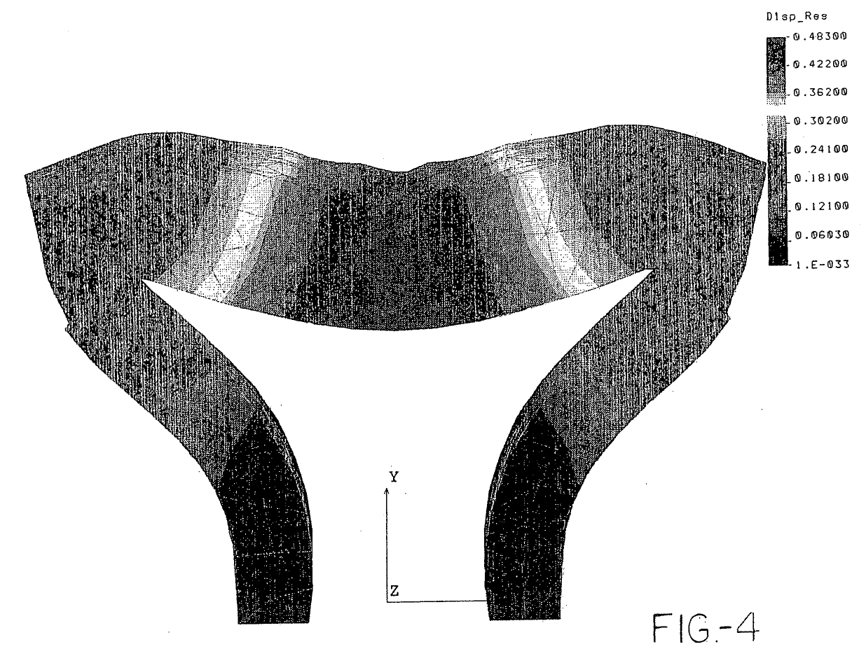

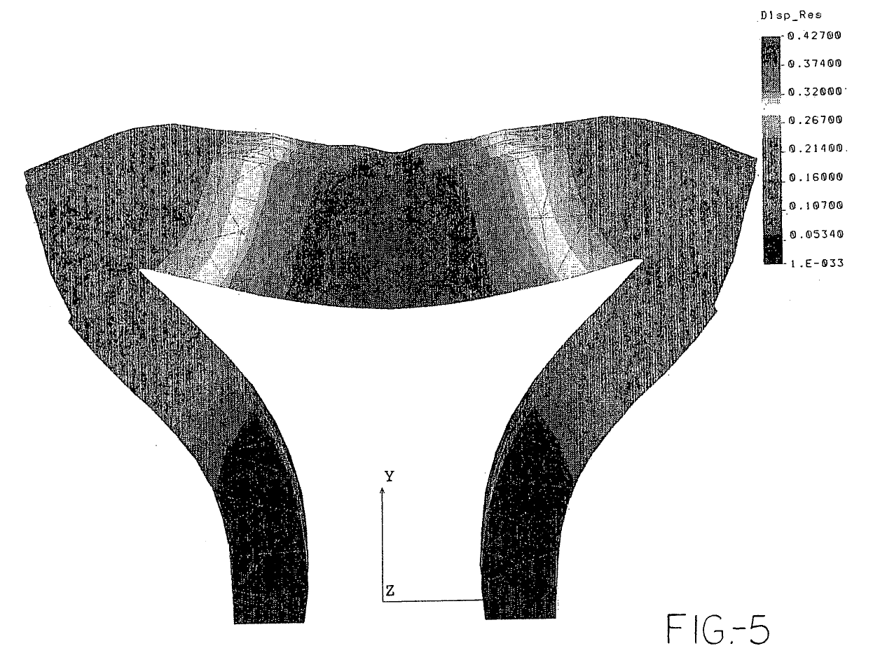

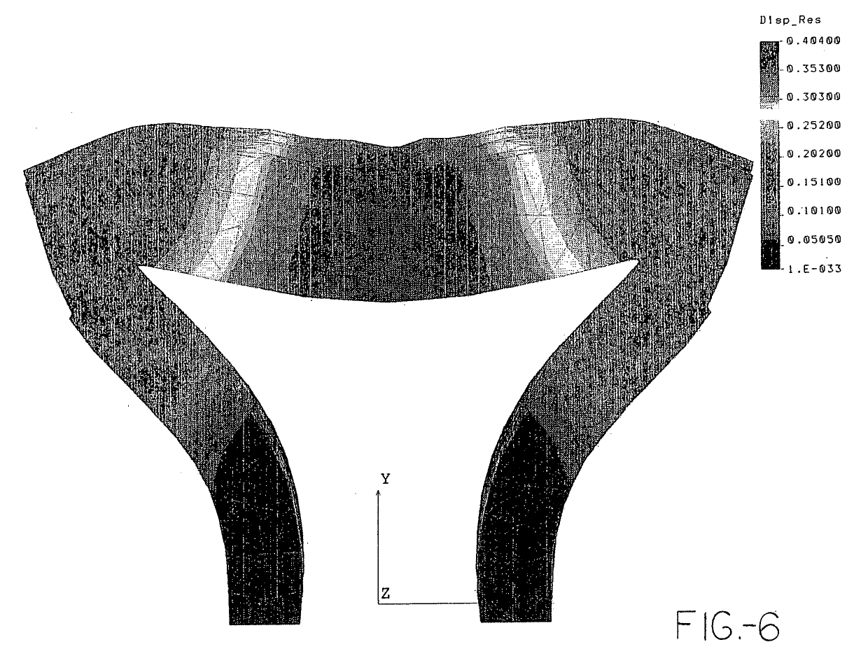

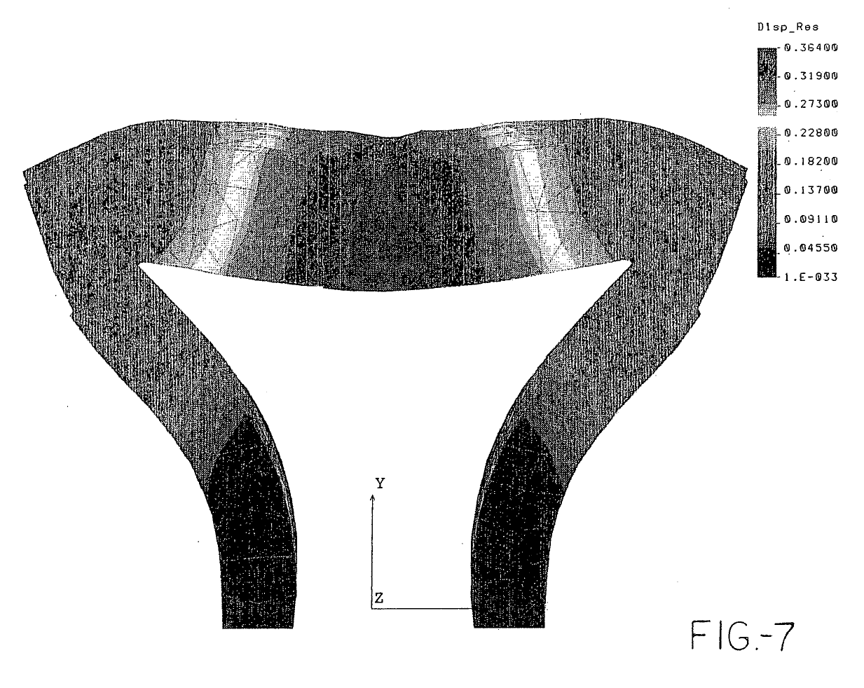

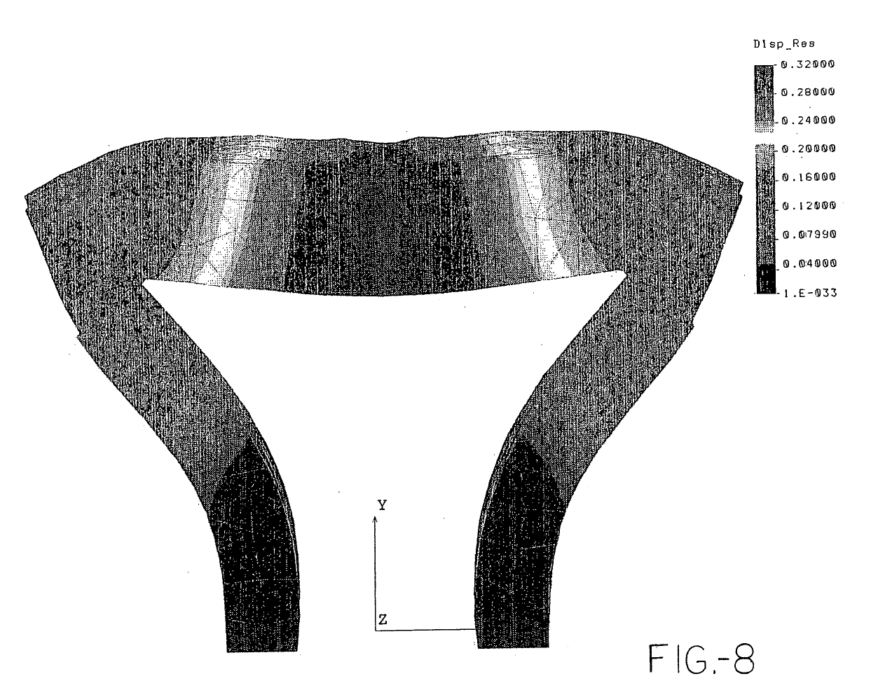

Turning to FIGS. 3-8, there are shown examples of finite element analysis cross-sectional depictions of tires 10, 110 according to these embodiments of the invention. For a given duty cycle for the tire 10, 110, stress within the tire may be evaluated using finite element analysis tools to optimize the tire design. As shown in FIGS. 3-8, stress within the cross-section of the tire 10, 110, upon loading is shown in these Figs. for differing material formulations, based upon a strength index of the material. In FIG. 3, a tire 10, 110 is shown in an unloaded state, with stress relatively evenly distributed throughout the cross-section of the tire. The examples shown in these figures are representative of a tire design having a cross-sectional sidewall gauge (SW) of 0.190 inches and varying material densities, which can be easily accomplished in the liquid phase manufacturing process as an example. In FIGS. 4-8, material density, ∂_{MF} are set at 25.0, 27.5, 28.0, 30.0, 35.0 and 39.0 respectively, with the stress characteristics within the tire shown therein. As can be seen in FIG. 4, a tire according to this design having a material density of 25.0 LB/FT³, when analyzed by non-linear finite element analysis (FEA), reveals a large deflection capacity on the tread portion of the tire and the stress distribution therein. In FIG. 5, a material density of 27.5 LB/FT³ results in less deflection of the tread portion, and better distribution of stress. As material density (∂MF) increases from 28.0 LB/FT³ in FIG. 6, to 30.0 LB/FT³ in FIG. 7, 35.0 LB/FT³ in FIG. 7 and 39.0 LB/FT³ in FIG. 8, it is seen that the deflection of the tread portion is further reduced, and stress characteristics within the tire are shown. From an FEA analysis of this type, a combination of material density and cross-sectional net to gross is found which would perform similar or equivalently to a pneumatic tire based upon weight and strength requirements to provide desired deflection characteristics in the tire design. In this example, for a cross-sectional gauge (SW GA) of 0.190, and a tire weight of 2.260, the following deflection (def) characteristics were found according to Table 1 wherein:

TABLE 1

| SW GA | Wt. Est. | ∂MF | def |
|---|---|---|---|
| 0.190 | 2.260 | 39.0 | 0.278 |
| 0.190 | 2.260 | 35.0 | 0.320 |
| 0.190 | 2.260 | 30.0 | 0.364 |
| 0.190 | 2.260 | 25.0 | 0.483 |
| 0.190 | 2.260 | 27.5 | 0.427 |
| 0.190 | 2.260 | 28.0 | 0.404 |
| 0.190 | 2.260 | 27.9 | 0.406 |

Thereafter, stress may be normalized at different locations of the tire design for finalizing a design for a given duty cycle. In the examples as shown in FIGS. 3-8, the tire was designed for a duty cycle of 200 lbs. at 30 mph as an example. It should therefore be evident that the tire design may be optimized for a given duty cycle to obtain deflection characteristics similar to pneumatic tires, thereby providing performance characteristics similar thereto. At the same time, the tire according to the invention provides significantly enhanced characteristics over and above pneumatic tires, including reduced rolling resistance. Rolling resistance can be further reduced if pneumatic pressure is also used within the annular chamber 18 of the tire 10, 110. The benefits of reduced rolling resistance can be optimized in conjunction with other operational characteristics of the tire 10, 110.

In Table 2, tread design data and tire design data are set forth for known pneumatic tires and non-pneumatic tires according to the invention.

TABLE 2

| | | Tread Design Data | | | | | | | | | |
|---|---|---|---|---|---|---|---|---|---|---|---|
| | | | N/S | | | UVV | | | | | |
| | | | In | | | In³/In | | | A.N/G | | |
| P = Pneumatic | | 26x | Non- | N/G % | V/G % | Unit | Hardness | | % A | | |
| N = Non- | Manufacturer | outer | skid | Net/ | Vol/ | Void | Shore A | | Area | Tire Design Data | |
| Pneumatic | Type | dia. | depth | gross | gross | Vol. | TD | SW | N/G | OD IN | SW In |
| P | Specialized | 1.95 | 0.142 | 0.250 | 0.75 | 0.10650 | 62 | N/A | 15.50 | 26.559 | 1.936 |
| | MT | | | | | | | | | | |
| P | Kenda | 1.95 | 0.085 | 0.490 | 0.51 | 0.04335 | 70 | 71 | 34.80 | 25.906 | 1.762 |
| | RD | | | | | | | | | | |
| P | Continent- | 1.60 | 0.077 | 0.520 | 0.48 | 0.03696 | 67 | 70 | 34.80 | 25.625 | 1.747 |
| | al | | | | | | | | | | |
| | Electric | | | | | | | | | | |
| P | St. | 2.15 | 0.110 | 0.676 | 0.33 | 0.03630 | 70 | 78 | 42.30 | 26.546 | 2.130 |
| | Electric | | | | | | | | | | |
| P | Cheng | 1.95 | 0.177 | 0.440 | 0.56 | 0.09912 | 65 | 76 | 28.60 | 26.187 | 1.961 |
| | Shin MT | | | | | | | | | | |
| | EST | | | | | | | | | | |
| N | Example | 1.95 | 0.156 | 0.50 | 0.50 | 0.07800 | 87 | 62 | 39.00 | 25.406 | 1.878 |
| | #1 | | | | | | | | | | |
| N | Example | 1.95 | 0.127 | 0.060 | 0.40 | 0.05080 | 93 | 57 | 37.20 | 25.640 | 1.840 |
| | #2 | | | | | | | | | | |
| N | Example | 1.95 | 0.125 | 0.660 | 0.34 | 0.04250 | 100 + 90 | 61 | 39.20 | 25.937 | 1.897 |
| | #3 | | | | | | | | | | |
| N | Example | 1.95 | 0.177 | 0.460 | 0.54 | 0.09558 | 62 | N/A | 28.50 | 25.690 | 1.790 |
| | #4 | | | | | | | | | | |

| | | | | |
|---|---|---|---|---|
| Wear | Wet | Grip Index | Dry | Shape Index |
| Index | Traction | | Traction | |
| | Index | | Index | |

| | | Tire Design Data | | | | | | |
|---|---|---|---|---|---|---|---|---|
| | | | SSR @ | | | | | |
| | | | 150 lbs | | Wc Ft- | | | |
| | | □ MF | Lb/In | | Lbs | | | |
| P = Pneumatic | | Lbs/Ft³ | Static | | Work | | | |
| N = Non- | Manufacturer | Matl. | Spring | d In | of | | Wt. | Vol |
| Pneumatic | Type | Density | ratio | defl. | compression | εm % | Lbs | Ft³ |
| P | Specialized | 21.800 | 193.000 | 0.777 | 9.7125 | −0.7350 | 2.26 | 0.1037 |
| | MT | | | | | | | |
| P | Kenda | 14.550 | 303.500 | 0.415 | 5.1880 | 1.3080 | 2.06 | 0.1416 |
| | RD | | 302.100 | | | | | |
| P | Continent- | 12.500 | 277.300 | 0.541 | 6.7630 | 1.2360 | 1.72 | 0.1376 |
| | al | | | | | | | |
| | Electric | | | | | | | |
| P | St. | 16.850 | 214.600 | 0.683 | 8.5380 | 0.1720 | 2.80 | 0.1662 |
| | Electric | | | | | | | |
| P | Cheng | 21.997 | 247.930 | 0.605 | 7.5630 | 2.0700 | 2.44 | 0.1109 |
| | Shin MT | | | | | | | |
| | EST | | | | | | | |
| N | Example | 30.760 | 281.950 | 0.532 | 6.650 | 3.9650 | 2.54 | 0.0826 |
| | #1 | | | | | | | |
| N | Example | 23.300 | 280.400 | 0.535 | 6.6880 | 4.2660 | 2.66 | 0.1142 |
| | #2 | 22.800 | 278.700 | 0.548 | 6.8500 | 1.9790 | 2.52 | 0.1102 |
| N | Example | 27.040 | 354.000 | 0.577 | 7.2130 | 2.8910 | 3.79 | 0.1402 |
| | #3 | 22.830 | 279.300 | | | | 3.20 | 0.1402 |
| N | Example | 21.900 | 367.650 | 0.408 | 5.1000 | 2.0000 | 2.22 | 0.1012 |
| | #4 | | | | | | | |
| | | Strength | Siffness | | Rolling | Mounting | Economic | Size |
| | | Index | Index | | Resistance | Ease | Index | Index |
| | | | | | Index | Index | | |

Physical characteristics of pneumatic tires for use with power bikes are shown, along with tire design data and performance characteristics. It is noted for example with the MT model tire produced by Specialized, the tire has a stiffness index SSR at a 150 lb. load, of 193.0 LB/IN, yielding a rolling resistance index W_{C} of 9.7125 FT-LBS. For the non-pneumatic tires according to the present invention, examples 1-4 are shown having varying tread and tire design characteristics, but in each case, providing performance characteristics which are greatly improved over the pneumatic tires shown in Table 2. In each of the examples 1-4, it is noted that relatively high stiffness indexes (SSR) are provided in the tire designs, yielding a rolling resistance index (W_{C}) which is significantly reduced. Although certain of the known pneumatic tires have reasonably good rolling resistance indexes (W_{C}), being similar to that achieved in the tire designs according to the invention, it should be apparent that the tire design according to the invention produces lower rolling resistance generally, and significant improvements for certain tire designs. Further, as previously mentioned, rolling resistance may be further reduced by introducing pneumatic pressure to the annular chamber formed in the closed torus tire design according to the invention.

A tires rolling resistance is generally effected by its environment as well as by the engineering of the tire, wherein tread compression characteristics, tread bending characteristics, as well as the material from which the tire is made, each will have an impact upon rolling resistance. It is known in pneumatic tires, that a worn out tire can have up to a 15% lower rolling resistance than a new tire due to lower traction and weight. Therefore, reducing mass and increasing inflation pressure directly reduces rolling resistance in a pneumatic tire. For a passenger tire, a typical range of rolling resistance measured in pounds drag/pounds load is between 10 to 25, whereas a light truck type of vehicle may have a rolling resistance in the range of 7 to 15 and a medium truck a rolling resistance in the range of 5 to 10. In the present invention, the design of the tire as well as the ability to make it from a homogenous material such as a urethane, provide significantly reduced rolling characteristics in the tires. With respect to the material, it is generally known that the higher the hysteresis losses within the material due to vibration, the higher the rolling resistance. Therefore, the stress and strain of the compound has been quantified in terms of loss modulus G¹¹ and storage modulus G¹. The angular phase lag of strain behind stress is defined as tan ∂ or G¹¹/G¹ and is the basic parameter for expressing energy losses relative to energy stored between 1500 and 2500 PSI for low amplitude vibrations at 60 HZ and room temperature.

The coefficient of rolling resistance of a tire is defined as the drag force divided by the vertical load and is related to power loss as follows:

| | | | |
|---|---|---|---|
| R = P/60 S L | P = ft./lbs./min, | S = ft. sec., | L = lbs. |

Power losses of tires have been measured on various rubber compounds to vary by approximately 1.5 times. Rolling resistance is thus also affected by the materials used in the tire construction, and the ability to use a low loss material in the construction of the tire according to the invention facilitates engineering the tire with a much reduced rolling resistance as compared to pneumatic tire constructions.

Experiments with urethane compounds when comparing them to rubber show the chemical bonds to be 4-6 times stronger with tan ∂'s one fourth of those for rubber. This could be due to the molecular structure and bond length differences, where rubber is a linear double-ionic bond structure and urethane is a three-dimensional double or triple, covalent bond structure. This increases packing and shortens urethane bond lengths.

Utilizing the work of compression as an index for the design/compound integral. The following data was generated for 700-20 bicycle tires.

| Tire Configuration | Pressurization | W_{c} (ft. lbs.) |
|---|---|---|
| Continental LA 19 MM | @ 100 psi | 3.050 |
| | @ 170 | 1.666 |
| Example A | @ 0 psi | 1.542 |
| Example B | @ 0 psi | 2.283 |

These data indicate that the tires according to the present invention as shown in Examples A and B can be engineered using stronger, lighter and cheaper materials in much more effective design configuration. Approximately a 34.5% reduction in rolling resistance and 17.25% in fuel economy may be achievable. At the current petroleum prices, it should be evident that significant fuel cost savings would be accomplished.

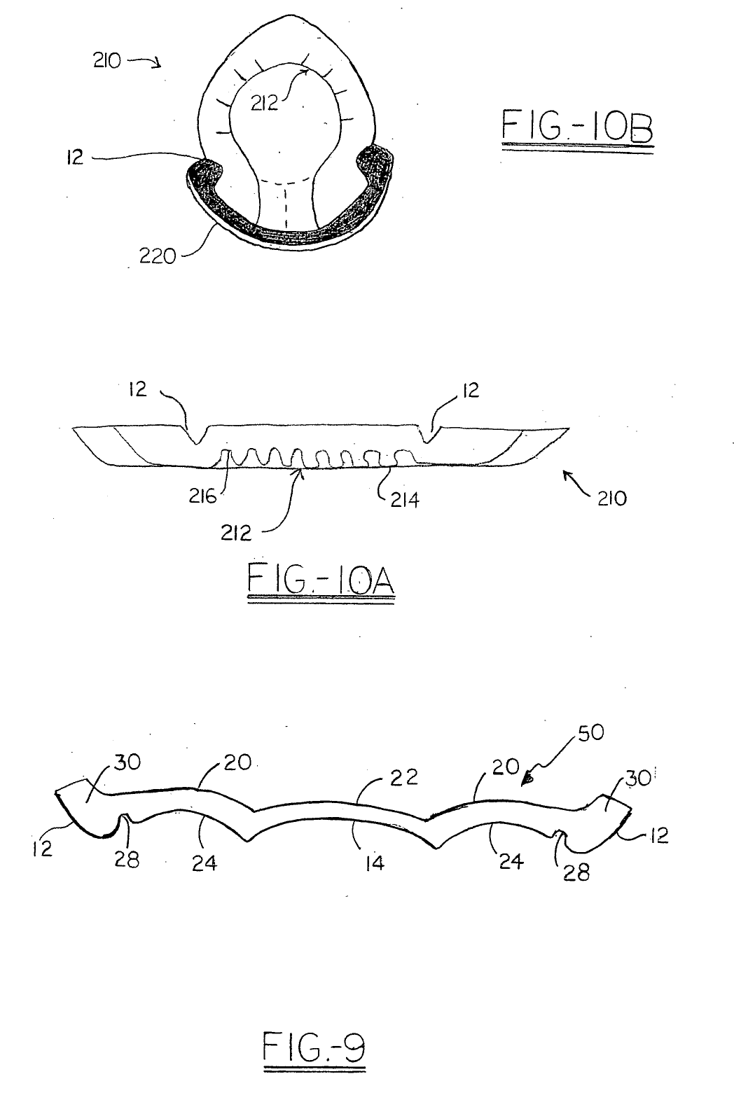

As previously briefly described, the tire 10, 110 of the present invention need not be laid down in plies like the conventional pneumatic tire. Instead, the tire 10, 110 is homogeneous, and may be formed from a variety of techniques known for forming elastomeric materials, such as compression or injection molding, spin casting or extrusion. Likewise, the manufacturing process can utilize either solid or liquid phase manufacturing, allowing rapid dispersion of the elastomeric materials, and a simplified and cost effective manufacturing process. The tire 10, 110 may be formed from a variety of known elastomeric materials, including, for illustration rather than limitation, natural rubber, modified rubbers, urethanes, polyurethanes or other suitable elastomeric materials for a particular application. A further embodiment of the tire of the present invention is shown in FIG. 9, in which a section of the tire body 50 is shown. The tire body 50 in this generally flat conformation is produced by extrusion of a curable polymeric material which is cured during the extrusion process. When a length of this tire body 50 appropriate for the circumference of the tire to be formed is cut from the extrudate, the tire body may be conformed or compressed into the rim, causing loading of the tire in compression. The compressional support can again be complemented using pneumatic pressure provided to add tensional support if desired. Certain structural markers already pointed out in the tire 10, 110 of previous embodiments are apparent in the unconformed tire body 50 of FIG. 9. Some of these markers include the rim-engaging surfaces 12, the road-engaging surface 14, the internal sidewall faces 20, the external sidewall faces 24, the internal top wall face 22, the lobe-like thickened portions 30 and concave groove 28. From these markers, the compressional conformation of the body 50 into the tire is rendered clear.

Turning to FIGS. 10A and 10B, a further alternative embodiment of the invention is shown. In FIG. 10A, a tire 210 is designed for manufacture by molding using liquid phase manufacturing, such that the tire 210 is formed as a relatively flat member having dimensional characteristics for use in a desired application in association with a known vehicle rim. For a known rim 220 as shown in FIG. 10B, the tire 210 is molded flat at the bead diameter, with rim engaging surfaces 12 formed on a face thereof. On the opposing face, anisotropic features 212, which may be a series of ridges and grooves 214 and 216 may be formed in the molded tire body 210. Upon assembly with rim 220 as seen in FIG. 10B, the anisotropic features 212 form circumferential anisotropic features one tire 210 is formed into the closed torus configuration in association with rim 220. As seen in the mounted configuration to rim 220, the circumferential anisotropy will facilitate forming the tire into the desired shape, and will distribute load stresses through the tire in a desired manner. Also as seen in this embodiment, the outer lobes formed on the tire body 210 will engage an interior portion of the rim 220, but the rim 220 itself closes the torus configuration of the tire 210.

The tire 10, 110 of the present invention may be useful in any known application where a pneumatic tire is currently the preferred technology. Since the tire of the present invention is not dependent upon pneumatic pressurization to maintain its structural stability, the tire acts as a “runs flat” tire and provides safety beyond that known in the conventional pneumatic tire. It also provides advantages in remote operations or in high hazard situations, such as on military vehicles, where a pneumatic tire simply poses a great risk. In one set of applications, the tire of the present invention may be used on a situation where the ratio of the height of the tire as measured radially is less than 10% or so of the diameter of the wheel rim, as in a bicycle tire. In another set of applications, the tire of the present invention may be used on a situation where the ratio of the height of the tire is in the range of from about 20 to about 60% of the diameter of the wheel rim, as in an automobile tire.

The operational characteristics of the tire 10, 110 are effectively identical once the tire is mounted in a proper rim, and those characteristics are largely determined by the sidewalls 16, the cross member 13 and the annular chamber 18. These operational characteristics are illustrated in a series of figures numbered 3 through 8. These figures exemplify how the imposition of a weight load on the tire 10, 110 causes resilient deformation of the tire and distortion of the cross sectional shape of the annular chamber, in a manner which is comparable to a pneumatic tire.

The present invention provides a tire design which improves performance characteristics in operation, including extended mobility, and lower rolling resistance. The shape of the tire provides a rim interfering design, which in conjunction with the materials allow for energy resolution.

1. A tire for mounting on a wheel rim, comprising:
an integral homogeneous toroidal body having a pair of spaced-apart radially extending sidewalls and a cross member, each said sidewall having a first and a second end and an internal face and an external face, with the second end of each of the sidewalls integrally merging into the cross member;
a set of rim-engaging surfaces at the first end of each of the sidewalls;
at least one road-engaging surface on an external surface of the cross member; and
an annular chamber defined by the internal faces of the sidewalls and an internal top wall on the cross member opposite the at least one road-engaging surface;
wherein the set of rim-engaging surfaces includes a lobe-like portion at the first end of each of the sidewalls, the respective lobe-like projections being separable when the tire is not mounted on the rim, but being compressed into engagement when the tire is mounted in the rim, thereby closing the annular chamber.

2. The tire of claim 1 wherein the sidewalls are thick enough to be structurally stable.

3. The tire of claim 1 wherein the external face of each of the sidewalls is curved concavely.

4. The tire of claim 3 wherein the internal face of each of the sidewalls is curved concavely with respect to the annular chamber.

5. The tire of claim 1 wherein the thickness of the sidewall varies by more than 10%.

6. The tire of claim 1 wherein the external road-engaging surface of the cross member has a convex curvature across a width of the cross member.

7. The tire of claim 6 wherein the cross member has a constant thickness.

8. The tire of claim 1 wherein the tire body is homogeneously formed from an elastomeric material.

9. The tire of claim 8 wherein the elastomeric material is selected from a group consisting of: natural rubber, modified rubbers, urethanes and polyurethanes.

10. The tire of claim 8 wherein the tire body is compressionally conformed when mounted in the rim such that it is circumferentially anisotropic.

11. A tire for mounting on a wheel rim, comprising:
an integral homogeneous toroidal body having a pair of spaced-apart radially extending sidewalls and a cross member, each said sidewall having a first and a second end and an internal face and an external face, with the second end of each of the sidewalls integrally merging into the cross member;
a set of rim-engaging surfaces at the first end of each of the sidewalls;
at least one road-engaging surface on an external surface of the cross member; and
an annular chamber defined by the internal faces of the sidewalls and an internal top wall on the cross member opposite the at least one road-engaging surface;
wherein the set of rim-engaging surfaces includes a lobe-like portion at the end of each of the sidewalls conjoining the respective sidewalls and closing the annular chamber.

12. The tire of claim 11 wherein the sidewalls are thick enough to be structurally stable.

13. The tire of claim 11 wherein the external face of each of the sidewalls is curved concavely.

14. The tire of claim 11 wherein the internal face of each of the sidewalls is curved concavely with respect to the annular chamber.

15. The tire of claim 11 wherein the thickness of the sidewall varies by more than 10%.

16. The tire of claim 11 wherein the external road-engaging surface of the cross member has a convex curvature across a width of the cross member.

17. The tire of claim 16 wherein the cross member has a constant thickness.

18. The tire of claim 11 wherein the tire body is homogeneously formed from an elastomeric material.

19. The tire of claim 18 wherein the elastomeric material is selected from a group consisting of: natural rubber, modified rubbers, urethanes and polyurethanes.

20. A non-pneumatic tire for mounting on a wheel rim, comprising:
a toroidal body having a pair of sidewalls and a cross member,
a set of rim-engaging surfaces at the first end of each of the sidewalls;
at least one road-engaging surface on an external surface of the cross member; and
an annular chamber defined by the internal faces of the sidewalls and the cross member;
wherein the rolling resistance of the tire when mounted in association with a wheel rim is designed to be minimized while maintaining acceptable operational characteristics for a predetermined duty cycle.

21. A method of manufacturing a tire for mounting on a wheel rim comprising the steps of:
preparing a mold to produce a flat molded body conformable into a closed torus configuration,
using a homogenous elastomeric material in association with the mold to produce the molded body, the body having a pair of sidewalls and a cross member,
a set of rim-engaging surfaces at the first end of each of the sidewalls; and
at least one road-engaging surface on an external surface of the cross member;
conforming the flat body into a closed toroidal configuration and engaging the rim-engaging surfaces with a wheel rim.
